(19) United States
(12) Patent Application Publication
(10) Pub. No.: US 2021/0272099 A1
(43) Pub. Date: Sep. 2, 2021

(54) SYSTEM AND METHOD OF PROVIDING AND LOADING VALUE TO GIFT CARDS

(71) Applicant: RewardLayer, LLC, Irving, TX (US)

(72) Inventors: Matthew P. FRYE, Dallas, TX (US); Brian WINFIELD, Frisco, TX (US); David S. JONES, Lakeway, TX (US)

(73) Assignee: RewardLayer, LLC, Irving, TX (US)

(21) Appl. No.: 16/804,790

(22) Filed: Feb. 28, 2020

(51) Int. Cl. G06Q 20/34; G06K 7/14; G06Q 20/08

(52) U.S. Cl. CPC G06Q 20/342; G06Q 20/085; G06K 7/1417; G06K 7/1413

(57) ABSTRACT

A system and method are provided for the providing and loading of value to a gift card. A system for providing and loading value to a gift card optically recognizes information corresponding with gift cards and with gift card boxes to provide gift cards to a customer by assigning gift cards and gift card boxes to a customer's account in a gift card management system and to load a customer specified value to a non-activated gift card assigned in the gift card management system to customer's account.

### FIELD

Embodiments of the present disclosure generally relate to gift cards, and specifically to a system and method of providing and loading value to gift cards.

### BACKGROUND

Gift cards are a form of prepaid stored-value of money that may be used with a merchant. While a merchant may directly issue gift cards, gift cards are commonly sold by third parties, such as retailers and wholesalers. While the point of sale of a gift card may not be the merchant associated with the gift card, the merchant knows that the third party issued a valid gift card because gift cards are associated with a unique number, which may be a number on the card and/or contained in a magnetic strip or barcode. These gift cards are sold activated at the point of sale, meaning the customer has paid for the full value of the gift card and the gift card may be used. The gift card may be activated in a number of ways, with a customer paying after an employee has entered the unique number into a point of sale terminal or scanned a magnetic strip with a magnetic strip reader or a barcode with a barcode scanner at the point of sale terminal. Thus a customer pays for the gift card at the point of sale, even though the gift card may not be given or used for an indeterminate amount of time. Such gift card purchases require the customer go to the merchant's or third party's point of sale with money to pay for the gift card. The carrying of money presents a security risk as a customer may be robbed. Moreover, gift cards purchased through a merchant or third party require a customer to go to the point of sale when it is open, which is convenient for the merchant or third party, but may not be for the customer.

Customers may also buy gift cards from merchants or third parties online with the gift cards delivered through the mail. This manner of delivery, however, delays the customer receiving of the gift cards for the time it takes to deliver the gift cards. It also provides a risk of theft as the gift cards may be stolen from the mail. While gift cards may be mailed in envelopes that do not advertise there is a gift card inside, the size and lack of flexibility of a gift card can be determined by a thief without having to see the gift cards.

Virtual gift cards sold online are available both directly from merchants and from third parties. A virtual gift card is an electronic version of a gift card that includes a unique number that identifies an account tied to amount of money prepaid or pre-allocated to a merchant. While a virtual gift card is offered at any time for a customer to buy, a virtual gift card is not a physical card, which is something that many customers prefer so that the gift and/or presentation is of a physical card.

Gift cards are also purchased by businesses. A business may have multiple employees buying gift cards and may have difficultly coordinating or setting limits of the employees. Additionally, a business may also have a stock pile of gift cards, already paid for, for employees to give at some future date. Such a stock pile causes a business to spend money before the business needs to give a gift card and may present a cash flow problem. Further, a stock pile of activated gift cards may be stolen by a thief or an employee.

### BRIEF SUMMARY

Described herein are systems and methods of providing and loading value to gift cards. These systems and methods of providing and loading of value to gift cards allows for a customer to purchase physical gifts card on-demand by providing the customer with non-activated, physical gift cards that may be activated at the customer's convenience. In this way, gift cards may be paid for when they are ready to be given. A customer has an account with the system, and when a customer is ready to activate a non-activated gift card, the customer may use, for example, a smartphone's camera to optically recognize information corresponding to a gift card identification number on a gift card, confirm or provide a value to be loaded to the non-activated gift card, and load the value to the gift card. Payment for the value loaded may be processed at the time of the loading of value to the gift card. While such systems and methods provide customers with convenience of not having to purchase activated gift cards before they are ready to be given or at an inconvenient time, additional security and customer benefits of such systems and methods are made possible as described below. For example, the system may store payment information, thus purchasers of gift cards are not required to carry cash or encounter potential theft during or after the purchase of gift cards. Additionally, a system may track the number of non-activated gift cards associated with an account, and when an account is running low, the system may allow for automatically sending additional non-activated cards to a customer, such as corresponding to replenishment of the gift cards a customer has loaded and used. Further, certain customer accounts may allow for multiple users and the setting of limitations as to what users may be able to do. Thus such systems and methods provide an added layer of security that is not present in the sale of fully activated gift cards at retailers and third parties.

In one example embodiment, a system for loading value to a gift card is provided, the system comprising: a gift card comprising information corresponding to a gift card identification number; a customer device comprising a user interface and an optical input device; and a remote server configured to communicate with the customer device and with a gift card database; wherein the customer device is configured to: optically recognize the information corresponding to the gift card identification number with the optical input device to capture the gift card identification number; determine the gift card identification number; receive input via the user interface of a value to load to the gift card; transmit the gift card identification number, the value, and an account number to the remote server; wherein the remote server is configured to: receive the gift card identification number, the value, and the account number from the customer device; access the gift card database, wherein the gift card database contains information of a plurality of gift cards, including a gift card identification number assigned to each of the plurality of gift cards; determine if the received gift card identification number is in the gift card database; in response to determining that received gift card identification number is in the gift card database, load the value to the gift card database for the received gift card identification number; and transmit a confirmation to the customer device that the value has been loaded.

In another example embodiment, the remote server is further configured to determine if the received gift card identification number is assigned to the account number.

In another example embodiment, the gift card information corresponding to the gift card identification number is a gift card identifier.

In another example embodiment, the gift card identifier is at least one of a barcode and a QR code.

In another example embodiment, the customer device is further configured to determine a location of the customer device; wherein the customer device is further configured to transmit the location to the remote server; and the remote server is further configured to record the location to the gift card database for the gift card identification number.

In another example embodiment, the remote server is further configured to transmit a confirmation that the value has been loaded.

In another example embodiment, the remote server is further configured to process payment for the value loaded.

In another example embodiment, a method for loading value to a gift card is provided, the method comprising: optically recognizing, via an optical input device of a customer device, information corresponding to a gift card identification number on a gift card to capture the gift card identification number; determine the gift card identification number; receiving, via a user interface of the customer device, a value to load to the gift card; transmitting, from the customer device to a remote server, the value, the gift card identification number, and an account number; receiving, at the remote server, the value, the gift card identification number, and the account number from the customer device; determining if the received gift card identification number is in a gift card database that contains information of a plurality of gift cards, including a gift card identification number assigned to each of the plurality of gift cards; loading the value to the gift card database for the received gift card identification number in response to determining that the gift card identification number is in the gift card database; and transmitting a confirmation from the remote server to the customer device that the value has been loaded.

In another example embodiment, the determining if the received gift card identification number is assigned to the account number is prior to loading the value.

In another example embodiment, the method further comprises: determining a location of the customer device; transmitting the location from the customer device to the remote server along with the value and gift card identification number; and recording the location to the gift card database along with the value.

In another example embodiment, the gift card database that contains information of a plurality of gift cards further contains a first merchant or a first brand assigned to the gift card identification number; and transmitting the first merchant or the first brand from the remote server to the customer device along with that the value has been loaded.

In another example embodiment, the method further comprises processing, by the remote server, payment for the value loaded.

In another example embodiment, a system for providing a gift card, the system comprising: a gift card box comprising information corresponding to a gift card box identification number and a plurality of gift cards, wherein each of the plurality of gift cards comprises information corresponding to a gift card identification number; a customer device comprising a user interface and an optical input device; a remote server configured to communicate with the customer device and with a gift card database; wherein the customer device is configured to: optically recognize the information corresponding to the gift card box identification number with the optical input device to capture the gift card box identification number; determine the gift card box identification number; transmit account information and the gift card box identification number to the remote server; wherein the remote server is configured to: receive the account information and the gift card box identification number from the customer device; access the gift card database, wherein the gift card database contains information of a plurality of gift card boxes and information of a plurality of gift cards, including (A) a gift card box identification number assigned to each of the plurality of gift card boxes, (B) a gift card identification number assigned to each of the plurality of gift cards, and (C) the gift card identification numbers assigned to each of the plurality of gift card boxes; determine if the received gift card box identification number is in the gift card database; in response to determining that gift card identification number received is in the gift card database, assign the gift card identification numbers assigned to the gift card box identification number received to the account.

In another example embodiment, the gift card box is purchased from a physical location.

In another example embodiment, the remote server is further configured to: receive a selection of gift cards for an account; allocate the selection of gift cards to the gift card box; transmit instructions to deliver the gift card box to the customer; determine that the gift card box was delivered to the customer in response to determining that the received gift card box identification number in the gift card database.

In another example embodiment, the gift card box information corresponding to the gift card identification number is a gift card identifier.

In another example embodiment, the gift card box identifier is at least one of a barcode and a QR code.

In another example embodiment, the remote server is further configured to transmit a confirmation that the gift cards associated with the gift card identification numbers assigned to the gift card box identification number has been assigned to the account.

In another example embodiment, a method for providing a gift card is provided, the method comprising: optically recognizing, via an optical input device of a customer device, information corresponding to a gift card box identification number on a gift card box to capture the gift card box identification number; determine the gift card box identification number; transmitting, from the customer device to a remote server, account information and the gift card box identification number; receiving, at the remote server, the gift card box identification number and the account information from the customer device; determining if the received gift card box identification number is in a gift card database that contains information of a plurality of gift card boxes and information of a plurality of gift cards, including (A) a gift card box identification number assigned to each of the plurality of gift card boxes, (B) a gift card identification number assigned to each of the plurality of gift cards, and (C) the gift card identification numbers assigned to each of the plurality of gift card boxes; assigning the gift card identification numbers assigned to the gift card box identification number received to the account in response to determining that the gift card box identification number is in the gift card database.

In another example embodiment, the method further comprises purchasing the gift card box from a physical location prior to optically recognizing, via an optical input device of the customer device, information corresponding to the gift card box identification number.

In another example embodiment, the method further comprising: receiving, prior to operatically recognizing information corresponding to a gift card box, a selection of gift cards; allocating the selection of gift cards to the gift card box; transmitting instructions to deliver the gift card box to the customer; determining, contemporaneously with determining if the received gift card box identification number is in a gift card database, that the gift card box was delivered to the customer in response to determining that the received gift card box identification number in the gift card database.

In another example embodiment, the method further comprises transmitting a confirmation that the gift cards associated with the gift card identification numbers assigned to the gift card box identification number has been assigned to the account.

The above summary is provided for purposes of summarizing some example embodiments to provide a basic understanding of some aspects of the disclosure. Accordingly, it will be appreciated that the above-described embodiments are examples. It will be appreciated that the scope of the disclosure encompasses many potential embodiments in addition to those here summarized, some of which are further described below.

### BRIEF DESCRIPTION OF THE DRAWINGS

Having thus described some embodiments in general terms, references will now be made to the accompanying drawings, which are not drawn to scale, and wherein:

FIG. 1 illustrates an example system in accordance with various embodiments of the present disclosure;

FIG. 2A illustrates an example of a first side of a gift card in accordance with various embodiments of the present disclosure;

FIG. 2B illustrates an example of a second side of a gift card in accordance with various embodiments of the present disclosure;

FIG. 2C illustrates an example of a second side of a gift card in accordance with various embodiments of the present disclosure;

FIG. 2D illustrates an example of a second side of a gift card in accordance with various embodiments of the present disclosure;

FIG. 3 illustrates an example gift card box in accordance with various embodiments of the present disclosure;

FIG. 4 illustrates an example customer device in accordance with various embodiments of the present disclosure;

FIG. 5A illustrates an example system architecture schema of an account in accordance with various embodiments of the present disclosure;

FIG. 5B illustrates an example system architecture schema of an account in accordance with various embodiments of the present disclosure;

FIG. 5C illustrates an example system architecture schema of an account in accordance with various embodiments of the present disclosure;

FIG. 6 illustrates an example flow chart showing an exemplary method of providing value and loading value to a gift card in accordance with various embodiments of the present disclosure;

FIG. 7 illustrates an example flow chart showing an exemplary method of building a personalized gift card box in accordance with various embodiments of the present disclosure;

FIG. 8 illustrates an example flow chart showing an example method of building a personalized gift card in accordance with various embodiments of the present disclosure;

FIG. 9 illustrates an example of an interface in accordance with various embodiments of the present disclosure;

FIG. 10 illustrates an example of an interface in accordance with various embodiments of the present disclosure;

FIG. 11A illustrates an example of an interface in accordance with various embodiments of the present disclosure;

FIG. 11B illustrates an example of an interface in accordance with various embodiments of the present disclosure;

FIG. 12 illustrates an example of an interface in accordance with various embodiments of the present disclosure;

FIG. 13A illustrates an example of an interface in accordance with various embodiments of the present disclosure;

FIG. 13B illustrates an example of an interface in accordance with various embodiments of the present disclosure;

FIG. 14 illustrates an example of an interface in accordance with various embodiments of the present disclosure.

### DETAILED DESCRIPTION OF VARIOUS EMBODIMENTS

Various embodiments of the present disclosure will be described more fully hereinafter with reference to the accompanying drawings, in which some, but not all, embodiments are shown. Indeed, the present disclosure may be embodied in many different forms and should not be construed as limited to the embodiments set forth herein. Rather, these embodiments are provided so that this disclosure will satisfy applicable legal requirements.

The term “or” is used herein in both the alternative and conjunctive sense, unless otherwise indicated. Like numbers refer to like elements throughout.

Described herein are systems and methods of providing and loading value to gift cards. These systems and methods of providing and loading of value to gift cards allows for a customer to purchase physical gifts card on-demand by providing the customer with non-activated, physical gift cards that may be activated at the customer's convenience and using, for example, a customer's smartphone. Non-activated gift cards may be purchased or received in a gift card box that may contain multiple non-activated gift cards. Gift card boxes may be available at retailer's or merchant's physical store (e.g., Costo Wholesale or Best Buy) or online. The customer may activate a non-activated gift card at the customer's convenience. Non-activated gift cards provide security to customers, particularly customers not ready to use the gift cards at the time the non-activated gift card is purchased or received. For example, an activated gift card could be stolen due to its value and the anonymity it provides, similar to cash. Non-activated gift cards, in comparison, do have the same value because no value has been loaded and the non-activated gift card is not ready to be used. A thief is not motivated to attempt to steal a non-activated gift card that may not have value or that may not be used.

A customer may purchase or receive a gift card box. Gift cards in a gift card box may be assigned to a customer account. The gift card management system may keep track of all gift cards by storing information about gift cards, such as gift card identification numbers in a gift card database. Prior to a non-activated gift card being provided to a customer, a gift card identification number corresponding to a gift card may be assigned to a gift card box, such as a gift card box a gift card is in. Further, a gift card identification number may be assigned to a gift card box without being assigned to an account in a gift card management system. A customer that purchased or received a gift card box may create or log into a customer account in a gift card management system. A gift card box may be assigned to the account. Assigning a gift card box to an account in a gift card management system may also assign gift cards assigned to the gift card box to the account because, for example, the gift cards may have already been assigned in gift card management system to the gift card box. In this example, assigning a gift card box to an account may cause all of the gift cards in the gift card box to be assigned to the account. Additionally, a customer account may also contain account details, such as payment processing information for the customer.

A customer may personalize gifts cards and gift cards boxes. Personalization is described further herein. If a customer personalizes a gift card or gift card box, the personalized box may be delivered through, for example, the mail. A gift card management system would not know if the personalized gift card box has been received by the customer. When a customer receives a personalized gift card box, optical recognition of information corresponding to a gift card box identification number or information corresponding with a gift card box identification number may confirm to the gift card management system that the customer has received the gift card box or gift cards. Such confirmation may also confirm that the gift card box or gifts cards shipped to the customer were not stolen prior to getting to the customer, such as being stolen in the mail.

When a customer is ready, a customer may activate a non-activated gift card by creating an account or logging into an account, using a device to optically recognize information corresponding to a gift card identification number on a gift card, confirm or provide a value to be loaded to the non-activated gift card, and load the value to the gift card. Payment for the value loaded to a gift card may be processed at the time of the loading of value to the gift card.

A customer's account may be configured to provide additional features. For example, the account may be configured for use with one or more users and one or more sub-users. Having users and sub-users may provide flexibility for customers, particularly in the examples of businesses or organizations that use gift cards, such as for gifts, incentives, promotions, rewards, rebates, and/or returns. In an alternative, which may depend on the context of the use of a gift card being as an incentive or as a reward, a gift card may be referred to an incentive card or a reward card. Additionally, the number of gift cards, non-activated and activated, associated with an account may be tracked, and when an account is running low, an account may be configured for replenishment, such as by automatically sending additional non-activated cards to a customer.

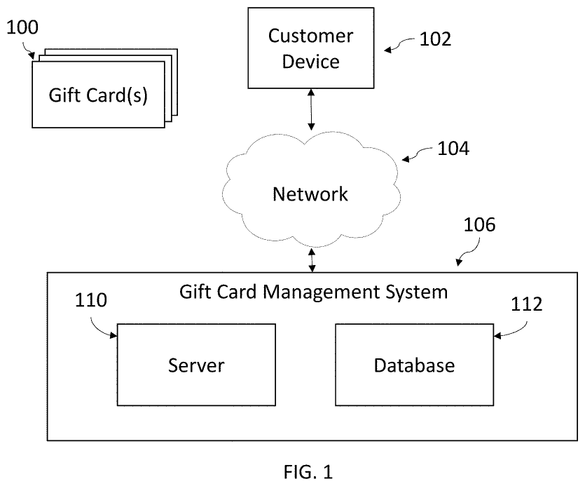

FIG. 1 illustrates an example system in accordance with various embodiments of the present disclosure. The system may include gift card(s) 100, customer device 102, network 104, and gift card management system 106. Gift card management system 106 may be communicably connected with customer device 102 via network 104, and gift card management system 106 may include server 110 and database 112.

Gift card(s) 100 may be one or more physical gift cards. When there are multiple gift cards, the gift cards may all be similar, may have one portion of gift cards with similarities, or may all be different in some respect. The gift card(s) 100 are described further herein.

Customer device 102 may be associated with a customer, such as a customer with an account in the gift card management system 106. Although a single customer device 102 is shown, any number of customer devices may be associated with and/or used by a customer or various other users or sub-users. Customer device 102 may be a mobile device and/or a stationary device. For example, customer device 102 may be a mobile device such as a mobile telephone (such as smartphone), laptop, tablet, and/or the like or similar mobile computing and/or communication devices. Additionally and/or alternatively, customer device 102 may be a customarily stationary device such as a desktop computer, work station, or the like.

Network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, network 104 may include a cellular telephone, mobile broadband, long term evolution (LTE), GSM/EDGE, UMTS/HSPA, IEEE 802.11, IEEE 802.16, IEEE 802.20, WiFi, and/or WiMax network. Furthermore, network 104 may include a public network, such as the Internet, a private network, such as an intranet, or any combinations thereof, and may utilize a variety of networking protocols now available or later developed including, but not limited to TCP/IP based networking protocols.

The gift card management system 106 may keep track of, among other things, gift card(s) 100. The gift card management system 106 may include a server 100 and a database 112. The gift card management system 106 is described further herein.

Server 110 may include circuitry, networked processors, or the like configured to perform some or all of the server-based processes described herein and may be any suitable network server and/or other type of processing device. In some embodiments, gift card management system 106 may function as a unified “cloud” with respect to customer device 102. In that sense, server 110 may include several servers performing interconnected and/or distributed functions. To avoid unnecessarily overcomplicating the disclosure, server 110 is shown and described herein as a single server.

Database 112 may be any suitable network storage device configured to store some or all of the information described herein. For example, database 112 may be configured to store gift card data (e.g., gift card identification numbers, gift card identifiers, merchants, brands, value, and/or location of the customer device when value was loaded), account data (e.g., account customer, account users, account sub-users, preferences, purchase history), device data (e.g., a device ID, an allowed location or area, an operating system), recipient data (e.g., name, a business and/or business identifier associated with a recipient, an address, an email address, a phone number, a relationship between the account and the recipient, when the recipient received the gift card, who gave the gift card 100 to the recipient, value of gift card(s) received by a recipient, an employee identification number, an employer identification number, a taxpayer identification number, if the value of a gift card 100 received is to be added to the recipient's pay, or a scenario in which the recipient received a gift card (e.g., a business scenario, family scenario, or personal scenario)), assignments (e.g., gift card identification numbers assigned to gift cards, gift card box identification number assigned to gift card boxes, gift card identification numbers assigned to gift card boxes, gift card identification numbers and gift card box identification numbers assigned to accounts, etc.), and/or purchase transaction data (e.g., shipping address, billing address, payment information (e.g., credit card numbers, checking account information and/or number(s), debit account information and/or number(s), wire transfer information and/or number(s), ACH Network information and/or number(s), account credit, PayPal, or Apple pay). As such, database 112 may include, for example, one or more database systems, backend data servers, network databases, cloud storage devices, etc. To avoid unnecessarily overcomplicating the disclosure, database 112 is shown and described herein as a single database device. In one example, the database may contain an entry for each gift card identification number and/or gift card identifier as well as any merchants or brands, value, and location of the customer device when value was loaded. Further, the database may contain more than one merchant or brand associated with a gift card identification number and/or gift card identifier.

Additionally, or alternatively, the database 112 may be configured to receive information from a customer's system by interfacing the gift card management system 106 with a customer system. For example, the gift card management system 106 may have an API that allows a customer to provide gift card data, account data, recipient data, and/or purchase transaction data to the gift card management system. In an example of a business that may give gift cards to employees as recognition and/or incentives, the business may provide the gift card management system 106 with employee information (e.g., recipient data) via the API. In another example, a customer may have contacts stored in a customer device 102 or in an email system that may be recipients of gift cards, and the customer may provide the gift card management system 106 with information about these contacts via an application or an API.

Additionally, or alternatively, the data in database 112 may be accessed via an interface by a customer or by an API. The customer may also query the data in database 112 in order to determine, for example, the number of gift cards given to one or more recipients. Additionally, or alternatively, the customer may generate reports from the database 112 to may be useful to the customer. For example, a customer may generate reports for tax reporting, reports for cash flow analysis, reports for which user or sub-user gives the most gift cards, and/or reports of the recipients that are associated with a business or business identifier. In another example, an individual that gives gift cards to recipients that are family members, a report may provide a number of gift cards 100 given to each family member, a value of gift cards 100 given, when the gift cards 100 were given, and if the gift cards 100 were used. In another example of two individuals sharing an account 500 and also desiring to provide a gift card 100 to a recipient, the two individuals could check the gift card system 106 to determine if a gift card had already been given to the recipient, such as by the other of the two individuals. This would prevent both a situation where the recipient received two gifts cards 100 and also a situation where the recipient did not receive a gift card 100 because each individual thought the other gave a gift card 100 but neither did.

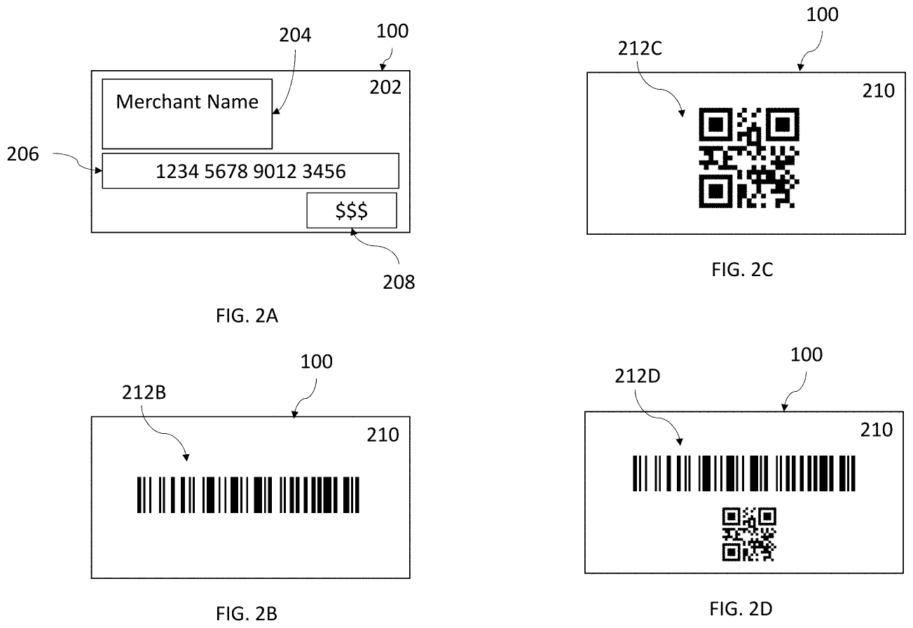

FIGS. 2A-2D illustrate examples of a first side and a second side of a gift card 100 in accordance with various embodiments of the present invention. FIG. 2A illustrates a first side 202 of a gift card 100 (e.g., the front) and FIG. 2B, FIG. 2C, and FIG. 2D illustrate the second side 210 of the gift card 100 (e.g., the back).

As illustrated in FIG. 2A, the first side 202 of gift card 100 may include a merchant name 204 and/or logo, a gift card identification number 206, and a value or value range 208. Alternatively, the gift card may omit one or all of the merchant name 204 and/or logo, the gift card identification number 206, or the value or value range 208. The printing of a value or value range on gift card 100 does not mean a value is loaded to the gift card 100. Moreover, the value or value range may not represent the value loaded to the gift card. For example, a gift card may be loaded with a value (e.g., $50) that is the initial value or value range 208 (e.g., $50), but after spending some of the initial value loaded to the card (e.g., spending $20) the remaining value loaded to the card (e.g., $30) would not be equal to the value or value range 208 shown on the gift card 100 (e.g., 50). A value is generally loaded to a gift card 100 contemporaneously with when the payment of the value occurs. Additionally, or alternatively, any of the above information may be located on the second side 210 of gift card 100.

The gift card identification number 206 may be a number or may include letters and/or special characters (e.g., !). When a gift card 100 includes a merchant name 204, the gift card identification number 206 for the gift card identifier 212 may have been assigned to a merchant or brand in the gift card management system 106. Additionally, or alternatively, the gift card identifier 212 may include information related to the design of the gift card 100 (e.g., the design of the images on the gift card 100), to a permissible value or permissible value range that may be loaded, and/or to information of one or more merchants or brands, such as a name of the merchant or brand, UPC associated with the merchant or brand, and/or other merchant of brand information.

FIG. 2B, FIG. 2C, and FIG. 2D illustrate three examples of a second side 210 of gift card 100. A gift card identifier 212 may be any identifier that may uniquely identify a gift card 10, such as, for example, a bar code and/or a QR code. Alternatively, the gift card identifier 212 may be any other image, symbol, or identifier that is capable of being used with optical recognition (e.g., optical character recognition). When used with optical recognition, the gift card identifier 212 may be converted to a gift card identification number or another identification number corresponding to the gift card identification number 206. FIG. 2B illustrates the gift card identifier 212B being a bar code. FIG. 2C illustrates the gift card identifier 212C being a QR code. FIG. 2D illustrates the gift card identifier 212D being a bar code and a QR code. A gift card identifier 212 may or may not be a representation of the gift card identification number 206 in an alternative format (e.g., a bar code or a QR code). The gift card identifier 212 (e.g., barcode and/or QR code) may correspond to the gift card identification number 206 or to the gift card identification number 206 and additional information. Additionally, or alternatively, any of the above information may be located on the first side 202 of gift card 100.

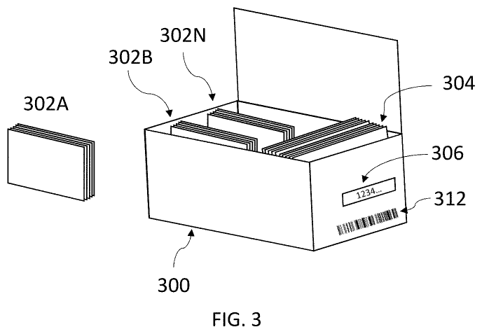

FIG. 3 illustrates an example gift card box 300 in accordance with various embodiments of the present disclosure. The gift card box 300 may include a plurality of gift card bundles 302A, 302B, . . . , 302N (collectively referred to herein a “gift card bundles 302” and individually as “gift card bundle 302” each including one or more gift cards 100), a plurality of gift card envelopes 304, gift card box identification number 306, and/or a gift card box identifier 312. The gift card box identification number 306 and gift card box identifier 312 may be located on the outside of the gift card box 300, on the inside of gift card box 300, or on something that comes inside or with the gift card box 300 (e.g., a confirmation card or receipt). When used with optical recognition, the gift card box identifier 312 may be converted to a gift card box identification number 306. The gift card box identification number 306 may be a number or it may include letters and/or special characters (e.g., !). Additionally, the gift card box identifier 312 may include information for one or more merchants or brands, such as a name of the merchant or brand, UPC, or other merchant of brand information. The gift cards 100 of the gift card bundles 312 included in a gift card box 300 may have been assigned to a gift card box identifier 312 and/or gift card box identification number 306 in a gift card management system 106.

Additionally, or alternatively, a gift card bundle 302 may have a gift card bundle identification number (not depicted in FIG. 3) and/or a gift card bundle identifier (not depicted in FIG. 3). The gift card bundle identification number and gift card box identifier may be located on the outside of the gift card bundle 302, on the inside of gift card bundle 302, or on something that comes inside or with a gift card bundle 302 (e.g., a confirmation card or receipt). When used with optical recognition, the gift card bundle identifier may be converted to a gift card bundle identification number. The gift card bundle identification number may be a number or it may include letters and/or special characters (e.g., !). Additionally, the gift card bundle identifier may include information for one or more merchants or brands, such as a name of the merchant or brand, UPC, or other merchant of brand information. The gift cards 100 of the gift card bundles may have been assigned to a gift card bundle identifier and/or gift card bundle identification number in a gift card management system 106. The gift cards bundles 302 may have been assigned to a gift card box identifier 312 and/or gift card box identification number 306 in a gift card management system 106.

Additionally, or alternatively, a gift card 100 may have a wrap or a sleeve (not depicted in FIG. 3). In one example, the sleeve may be a plastic sleeve that surrounds gift card 100. In another example, a wrap may be a wrap that surrounds a portion of the gift card. The gift card wrap or gift card sleeve may have a gift card wrap identification number or a gift card sleeve identification number and/or a gift card wrap identifier or gift card sleeve identifier. The gift card wrap identification number or gift card sleeve identification number may or may not be the same as the gift card identification number. The gift card wrap identifier or gift card sleeve identifier may or may not be the same as the gift card identifier. When used with optical recognition, the gift card warp identifier or gift card sleeve identifier may be converted to a gift card wrap identification number or a gift card sleeve identification number, respectively. The gift card wrap identification number or gift card sleeve identification number may be a number or it may include letters and/or special characters (e.g., !). Additionally, the gift card wrap identifier or gift card sleeve identifier may include information for one or more merchants or brands, such as a name of the merchant or brand, UPC, or other merchant of brand information. The gift card 100 in a gift card wrap or gift card sleeve may have been assigned to a gift card wrap identifier or a gift card sleeve identifier and/or gift card wrap identification number or gift card sleeve identification number, respectively, in a gift card management system 106. The gift card wrap identification number, gift card wrap identifier, gift card sleeve identification number, and/or gift card sleeve identifier may or may not have been assigned to a gift card bundle 302 identifier, a gift card bundle 302 identification number, a gift card box identifier 312 and/or gift card box identification number 306 in a gift card management system 106.

Additionally, or alternatively, a gift card box 300 may have a wrap or a sleeve (not depicted in FIG. 3). In one example, the sleeve may be a plastic sleeve that surrounds gift card box 300. In another example, a wrap may be a wrap that surrounds a portion of the gift card box 300. The gift card box wrap or gift card box sleeve may have a gift card box wrap identification number or a gift card box sleeve identification number and/or a gift card box wrap identifier or gift card box sleeve identifier. The gift card box wrap identification number or gift card box sleeve identification number may or may not be the same as the gift card box identification number. The gift card box wrap identifier or gift card box sleeve identifier may or may not be the same as the gift card box identifier. When used with optical recognition, the gift card box warp identifier or gift card box sleeve identifier may be converted to a gift card box wrap identification number or a gift card box sleeve identification number, respectively. The gift card box wrap identification number or gift card box sleeve identification number may be a number or it may include letters and/or special characters (e.g., !). Additionally, the gift card box wrap identifier or gift card box sleeve identifier may include information for one or more merchants or brands, such as a name of the merchant or brand, UPC, or other merchant of brand information. The gift card box 300 in a gift card box wrap or gift card box sleeve may have been assigned to a gift card box wrap identifier or a gift card box sleeve identifier and/or gift card box wrap identification number or gift card box sleeve identification number, respectively, in a gift card management system 106. The gift card box wrap identification number, gift card box wrap identifier, gift card box sleeve identification number, and/or gift card box sleeve identifier may or may not have been assigned to a gift card box identifier 312 and/or gift card box identification number 306 in a gift card management system 106.

In one example, a gift card box 300 may include 3 gift card bundles 302 and the gift card bundles 302 may each include 5 gift cards 100 for a total of 15 gift cards 100 in the gift card box 300. The quantity of gift cards in a gift card bundle 302 may vary and, as discussed below, may be set by a customer creating a personalized gift card box 300.

The gift card bundles 302 in a gift card box 300 may all be related to a category (e.g., electronics, clothing, food & beverage, beauty, or home improvement) or may be from different categories. In further examples, the gift card box 306 may be a starter box, a holiday box, a replenishment box, or a theme box. A starter box may have gift card bundles 302 for, for example, the most popular merchants, such as the most popular merchants in an area or the merchants assigned the most gift cards. A holiday box may have gift card bundles 302 associated with merchants selling holiday related goods. A replenishment box may have gift card bundles 302 or gift cards 100 associated with merchants for which a customer has already purchased or received gift card(s) 100. Additionally, or alternatively, replenishment may be with gift card bundles 302 or gift cards 100 without a gift card box 300, which may be gift card bundles 302 or gift cards 100 being provided or sent to, for example, a customer in order to replenish a gift card box 300 that was previously purchased. A theme box may be directed to one theme or category of merchant(s), such as food, entertainment, etc. As an example, a gift card box 300 with gift card bundles 302 for the electronic category may include gift card bundles 302 for Best Buy, Amazon, GameStop, Xbox, iTunes, and/or Target. Additionally, or alternatively, a gift card box 300 may be to a single merchant that may include multiple brands. For example, Darden Restaurants is a merchant that operates multiple brands, including Olive Garden, LongHorn Steakhouse, and Capital Grille. A gift card 100 to Darden Restaurants may be able to be used at any of its brands. A gift card box 300 to Darden Restaurants may have a gift card bundle 302 to each of its brands, such that a gift card 100 may be for a single brand of a merchant. Alternatively, a gift card 100 may be to more than one merchant or more than one brand, and these merchants or brands may be unrelated. For example, a gift card 100 may be to Best Buy as a first merchant and to Target as second merchant. A database 112 may contain each merchant or brand associated with a gift card 100, such as by assigning a merchant or brand to a gift card-identification number 206.

The gift card envelopes 304 may have designs that correspond the merchant or brand of the gift card bundles 302 or may have generic or personalized designs. Additionally, or alternatively, the gift card envelopes 304 may have designs that correspond to a specified value, a value range, or open value amount for a gift card 100 to be associated with a gift card envelope 304. A gift card envelope 304 may also have a personalized designs or image or photo associated with a customer, such as a personalized design for a business or for a family. For example, a business may have a design, image, or photo of the business's name, business location, a business logo, or employees of the business. In an example associated with a family, a family may have a design with an image or photo associated with their family, such as of the family, the family's pets, or the families name.

A gift card box 300 may be sold or distributed at retailers, wholesalers, or online. A retailer may sell gift card boxes that include the retailer as the merchant for a gift card bundle 302. Alternatively, a retailer may sell gift card boxes that include gift card bundles 302 associated with the category of products the retailer offers. For example, Best Buy could sell a gift box 300 with gift card bundles 302 for Best Buy and/or other merchants, such as Costco or Sam's Club, related to the electronics category. The gift card box 300 may alternatively be sold online from a website and, as discussed below, this may allow for selection of the merchants and/or brands the gift cards 100 are to and to personalize the gift card boxes 300.

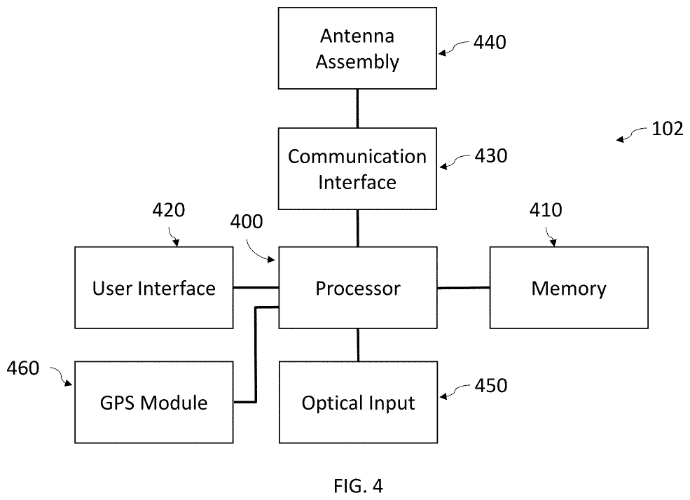

FIG. 4 illustrates an example customer device in accordance with various embodiments of the present disclosure. As shown in FIG. 4, a customer device 102 may include a processor 400, a memory 410, a user interface 420, a communication interface 430, an antenna assembly 440, an optical input 450, and/or a GPS module 460. Although FIG. 4 shows example components of a customer device 102, in other implementations, a customer device 102 may include fewer components, additional components, different components, or differently arranged components than depicted in FIG. 4. In still other implementations, one or more components of a customer device 102 may perform one or more tasks described as being performed by one or more other components of a customer device 102.

Processor 400 may include a processor, a microprocessor, an ASIC, a FPGA, or the like, or any combination thereof. Processor 400 may control operation of a customer device 102 and its components. In one implementation, processor 400 may control operation of components of the customer device 102 in a manner similar to that described herein. Memory 410 may include RAM, ROM, and/or another type of memory, or any combination thereof, to store data and/or instructions that may be used by processor 400.

User interface 420 may include mechanisms for inputting information by or to customer device 102 and/or for outputting information from customer device 102. Examples of input and output mechanisms might include buttons (e.g., control buttons, keys of keypad, a keyboard, a joystick, etc.); a touch screen interface to permit data and control commands to be input by or to customer device 102 via a display; a speaker to receive electrical signals and output audio signals; a microphone to receive audio signals and output electrical signals; a display to output visual information (e.g., user interfaces, web pages, etc.); a vibrator to cause customer device 102 to vibrate; a biometric identification mechanism to receive iris, retina, facial scan, fingerprint, toe print, DNA, etc.; and/or a light (e.g., LEDs, indicator lights of different colors, such as red, green blue, etc.).

Communication interface 430 may include a transceiver to perform functions of both a transmitter and a receiver of wireless communications, wired communications, or a combination of wireless and wired communications.

Antenna assembly 440 may include one or more antennas to transmit and/or receive signals over network 104. For example, antenna assembly 440 may receive signals from communication interface 430 and transmit them over network 104, and receive signals over network 104 and provide them to communication interface 430. Communication interface 430 may communicate, via antenna assembly 440, with a network 104 and/or a customer device 102 connected to a network 104.

Optical input 450 may capture an image and/or a video. Optical input 450 may be a camera or a sensor. Optical input 450 may be used in optical recognition (e.g., optical character recognition or object recognition) of an image, such as optical recognition of information corresponding to a gift card identification number 206 or gift card identifier 212 or a gift card box identification number 306 or a gift card box identifier 312. For example, a gift card identifier 212 may be a barcode, the optical input 450 optically recognizes the barcode and determines a gift card identification number from the barcode. For further example, a gift card identifier 212 may be a QR code, the optical input 450 optically recognizes the QR code and determines a gift card identification number from the QR code. For further example, a gift card 100 may have a barcode and a QR code, and optical input 450 may optically recognize both the barcode and, either at the same time or at a different time, the QR code, which may provide for an additional verification. A gift card 100 with a barcode and a QR code may be considered to have one gift card identifier 212 of both the barcode and QR code or may be considered to have two gift card identifiers 212, the first may be the barcode and the second may be the QR code. For a further example, the optical input may optically recognize gift card identification number 206 and also optically recognize gift card identifier 212, which may provide another manner of additional verification.

GPS module 460 may provide the location of customer device 102. GPS module 460 may determine the location using Global Positioning System (GPS) based on satellite signals or Assisted Global Positioning System (AGPS), such as based on signals from cellular phone towers or other location or positioning data. Other similar systems for determining the location of customer device 102 are also contemplated by the present disclosure. The location of customer device 102 may be provided as GPS coordinates or, alternatively, may be provided as a street address or any other location recognizing information.

Customer device 102 may perform certain operations described herein in response to processor 400 executing software instructions of an application contained in a computer-readable medium, such as memory 410. Software instructions may be read into memory 410 from another computer-readable medium or from another device via communication interface 430. Software instructions contained in memory 410 may cause processor 400 to perform processes that will be described later. Alternatively, hardwired circuitry may be used in place of or in combination with software instructions to implement processes described herein. Thus, implementations described herein are not limited to any specific combination of hardware circuitry and software.

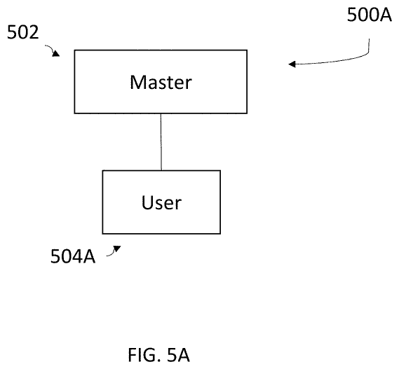

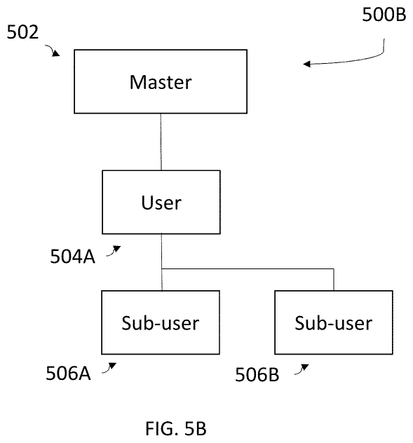

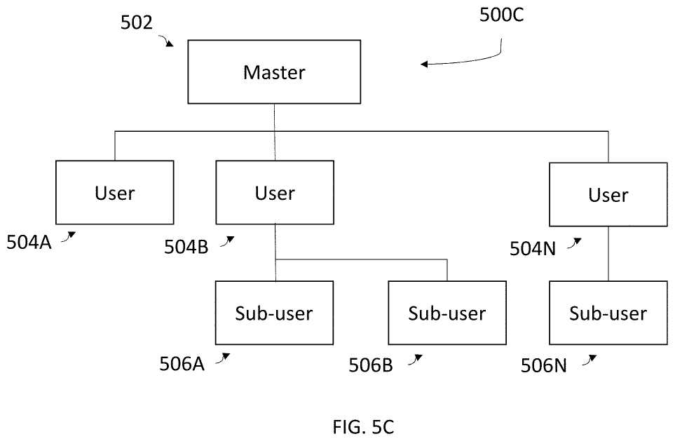

FIG. 5A, FIG. 5B, and FIG. 5C illustrate examples of system architecture schema of an account 500, such as a customer's account, in accordance with various embodiments of the present disclosure. A customer's account 500 may be stored in database 112 of a gift card management system 106. A customer creates an account with a gift card management system 106 by providing account information (e.g., name, password, etc.), and account 500 may be accessed with information used to a create account 500. A customer logs into account 500 to use the gift card management system 106. A customer may be associated with multiple accounts, such as a personal account, a master of a business account, or a user in a business account. A gift card management system 106 contains gift card data for each account, including storing the gift box identification numbers and gift card identification numbers associated with an account. Prior to being assigned to an account, gift card management system 106 contains information on non-activated gift cards 100, including gift card identification numbers 206, and gift card identification numbers 206 may be assigned to a gift card box 300 by the gift card box identification number 306. When a customer creates account 500 and adds gift card box 300 to the account, such as by optically recognizing gift card box identifier 312, the gift cards 100 in gift card box 300 are assigned to the customer's account 500. After the gift card identification numbers 206 are assigned to account 500, only account 500 may load value to the gift card 100. The assigning of gift cards 100 to account 500 provides security as only gift cards associated with their account may be loaded, and may only be paid for with payment methods associated with an account 500. As gift cards 100 are assigned to account 500, anyone who does not have access to the account 500 is deterred from taking, borrowing, or stealing gift cards because the gift cards may not be loaded with value. Even if someone had access to the account, further security may be restricting the loading of value to payment methods associated with the account 500. At the time of payment, payment methods may require additional information to be able to use the payment method. For example, a credit card may require a security code or authorization code before processing payment. In another example, Apple pay may require biometric identification, such as a fingerprint or facial recognition before processing payment. Additionally, or alternatively, further security may require an additional factor (e.g., for two or more factor authentication) associated with a payment method, such as another password, key, code, or identification of a device associated with a payment method. If payment methods associated with the account 500 are set to be the only payment methods allowed, anyone that may have access to the account but may not have access to the payment method would be deterred from taking, borrowing or stealing the gift cards 100. For example, a customer's family member may gain access to a customer's account 500 by guessing the accounts name and password, but without having, for example, the required biometric identification for Apple pay, the customer's family member would not be able to load value to a gift card.

For an account, a gift card management system 106 may keep track of how many gift cards 100 are associated with an account 500. The tracking may include, for example, how many activated and non-activated gift cards 100 are assigned to an account, and for which merchants or brands gift cards 100 may be assigned to. A gift card management system 160 may know when a customer is getting low on non-activated gift cards 100, such as by analyzing the number of non-activated gift cards 100 in view of a threshold. For example, an account may be set to replenish additional gift cards 100 once the account 500 reaches a certain minimum number of gift cards 100 (e.g., 2) remaining on the account 500 or a particular type of gift cards. For example, if an account 500 is assigned a gift card box 300 with 25 gift cards 100, the gift card management system 106 keeps track of when value has been loaded to these 25 gift cards 100. An account may be set for automatic replenishment of gift cards 100 to be sent to the address stored for the account once the number of non-activated gift cards 100 reaches 5 gift cards 100. Moreover, an account may be set to have refills be of the same gift cards 100 associated with the account 500 or gift cards 100 that are different, such as for different merchants or brands. Alternatively, or additionally, an account may be set to email or notify the account holder to order refills of gift cards 100.

Additionally, or alternatively, there may be multiple thresholds for an account 500. For example, a threshold may be associated with the number of non-activated gift cards 100 assigned to an account. For further example, a threshold may be specific to the number of non-activated gift cards 100 associated with a particular vendor or merchant. In a further example, a threshold may vary by the time of year, such as having a higher threshold during holiday seasons and a lower threshold outside of holiday seasons. In a further example, a threshold may be determined by the gift card management system 106 applying a statistical model or predictive analytics to determine the quantity of gift cards 100 that a customer will use in an upcoming time period and provide the customer with the predicted number of gift cards 100. In a further example, a threshold may vary with time periods, which may limit the total number of gift cards 100 provided as replenishments during a time period, such as a one month. Alternatively, the threshold may vary with time period and amount of value loaded to gift cards 100. The varying by time period and value, such as an average value, may be an option that a business account chooses in order to keep spending on gift cards within a business's budget. A threshold, including the type of threshold, may be an option that the customer sets in their account 500.

Referring now to FIG. 5A, an account 500A may include a master 502 and a user 504A. The master 502 may also be a user 504A. Alternatively, the master 502 may not be a user 504A. If the account 500 only has one user 504, as shown in FIG. 5A, the one user may be the master 502 and there may be no distinction in the account (e.g., the account may have only a master). For example, if only one individual is a user 504 and there are no other individuals with access to account 500, the one individual is the master 502.

Referring now to FIG. 5B, an account 500B may include a master 502, a user 504A, and a plurality of sub-users 506A, 506B, . . . , 506N (collectively “sub-users 506” and individually “sub-user 506”). The account 500B may have a master 502, and the master 502 may also be a user 504A. Alternatively, the master 502 may not be a user 504A. The account 500B may, for example, be a business account, the master 502 may be a manager while user 504A and sub-users 506 may be employees reporting the manager. To continue with this example, if one of the employees reporting to the manager also manages other employees, then the other employees may be a sub-user 506 in the account 500B. This hierarchical organization is illustrated in FIG. 5B with sub-user 506A and sub-user 506B reporting to user 504A and with user 504A reporting to master 502. While in the above example FIG. 5B is a business account, it may also be any other type of account, such as a family account.

Referring now to FIG. 5C, an account 500C may include a plurality of users 504A, 504B, . . . , 504N (collectively “users 504” and individually “user 504”) and a plurality of sub-users 506A, 506B, . . . , 506N (collectively “sub-users 506” and individually “sub-user 506”). The account 500C may have a master 502, and the master 502 may also be a user 504. Alternatively, the master 502 may not be a user 504. The account 500C may, for example, be a business account, the master 502 may be a manager while users 504 and sub-users 506 may be employees reporting the manager. To continue with this example, if one of the employees reporting to the manager also manages other employees, then the other employees may be a sub-user 506 in the account 500. This hierarchical organization is illustrated in FIG. 5C with sub-user 506A and sub-user 506B reporting to user 504B, with sub-user 506N reporting to user 504N, and with user 504A, user 504B, and user 504N reporting to master 502. While not depicted in FIG. 5C, a single sub-user 506 may report to multiple users 504. Additionally, while the exemplary system architecture schemas of FIG. 5A, FIG. 5B, and FIG. 5C include master 502, users 504, and sub-users 506, the architecture allows for additional levels below sub-user 506. While in the above example FIG. 5C is a business account, it may also be any other type of account, such as a family account.

An account 500 may additionally allow for master 502 to set limitations for users 504 and sub-users 506, and it may also allow for a user 504 to set limitations for sub-users 506. For example, a gift card box 300 may include, for example, 5 gift card bundles 302 that each contain 5 gift cards 100, and each gift card bundle 302 may be assigned to one of 5 users 504. In this example, each user 504 may have 5 gift cards 100 that the user 504 may use. Additionally, a master 502 may limit the value that a gift card 100 may be assigned by a user 604, which may allow for a master 502 to limit the total value of gift cards issued to an amount of a budget a master 502 has responsibility for. A master 502 may set a single payment method for all users 504 and sub-users 506 to use when assigning value to the cards. Alternatively, the account 500 may allow for each user 504 or sub-user 506 be assigned a separate payment method, such as a corporate credit card or account assigned to the user 504 or the sub-user 506. To continue with the example, an account 500 limiting the value of a gift cards 100 while allowing for separate payment methods for each user 504 and/or sub-user 506 allows for security in the account not to exceed a set budget for gift cards 100 while allowing the users 504 and/or sub-users 506 responsibility for tracking their own expenses with loading value to gift cards 100. Additionally, an account 500 may require approval by a master 502 or user 504 before additional gift cards 100 or gift card boxes 300 are assigned to the account 500. Such approval may be provided by email, application, notification, or text message.

A gift card 100 may be transferred between two accounts, such as between a first customer that has a gift card 100 assigned to their account and a second customer. An example of such a situation may be two neighbors each having a separate account when a first neighbor has run out of gift cards and desires to have a gift card 100 of the second neighbor. To transfer a gift card 100 between accounts, the first customer having the account with the gift card 100 may scan the gift card identifier 212 of the gift card 100 to be transferred and indicate that the gift card 100 is to be transferred to the second user, and the second customer may scan the gift card identifier 212 to confirm that the gift card 100 has been transferred. The gift card management system 106 may, based on the input of the first customer and second user, remove the gift card identification number 212 from the account of the first customer and assign the gift card identification number 212 to the account of the second user. Similarly, if an account has users and/or sub-users and a gift card 100 is assigned to the user or sub-user, a transfer between users and/or sub-users may occur.

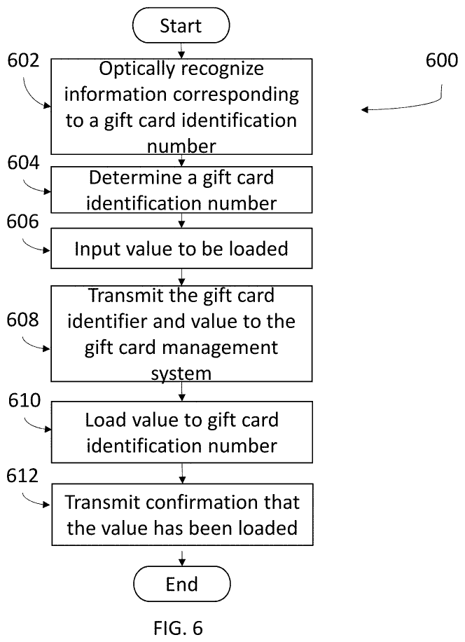

FIG. 6 illustrates an example flow chart 600 showing an exemplary method of providing and loading value to a gift card in accordance with various embodiments of the present disclosure. The example flow chart uses optical recognition of information corresponding to a gift card identification number (e.g., gift card identifier 212) to determine a gift card identification number 206 and an input value to load a value to a gift card 100. As discussed above, gift card identifiers 212 may be associated with a gift card 100 in a gift card bundle 302, and a gift card bundle 302 may include gift cards for a specific merchant or brand. The gift card management system 106 may track the merchant or brand that a gift card 100 is associated with by a gift card identification number related to the gift card identifier 212.

Referring now to FIG. 6, at step 602, the customer device 102 scans or takes an image of information corresponding to a gift card identification number (e.g., the gift card identifier 212) of a gift card 100 with optical input 450. At step 604, the customer device optically recognizes the gift card identifier 212 to determine a gift card identification number 206. For example, if the gift card identifier 212 is a barcode then the optical recognition of the barcode may be used in determining a gift card identification number 206 based on the information in the barcode. At step 606, a value to be loaded to the gift card 100 is input into customer device 102 via user interface 420. At step 608, the customer device 102 transmits the gift card identification number 206 and the value to the gift card management system 106. Additional information may also be transmitted, such as, for example, account information, user information, or sub-user information. At step 610, the value is loaded to the gift card identification number 206 in the gift card management system 106. Contemporaneously, or prior to the value being loaded, payment information for the value may be provided or the customer may select to use payment information stored in gift card management system 106 for an account 500 to process payment for the value being loaded. Alternatively, payment could be processed at another time, such as at the end of a business day. When the gift card management system 106 is not run by a merchant, but is instead run by a retailer, wholesaler, or third party, the gift card management system 106 registers the gift card 100 with the merchant and/or brand for the value loaded. Once the value has been loaded, the gift card is activated and may be used. At step 612, after the gift card management system 106 loads the value to the gift card identification number 206, a confirmation that the value has been loaded to the gift card 100 and that the gift card 100 is active and ready to be used will be presented and/or transmitted to the user. The confirmation may be provided to customer device 102. Additionally, or alternatively, the confirmation may be sent to by email, text message, and/or application notification.

Additionally, or alternatively, and prior to a value to be loaded to the gift card 100 is input into customer device 102 via user interface 420 at step 606, the gift card management system may present, such as via user interface 420, one or more permissible load amounts to be selected. A presentation of one or more permissible load amounts may be limited to specific amounts, which may be determined based on predetermined increments. A permissible load amount may be based on an account setting, a merchant or brand, a gift card identifier, a gift card box identifier, or other information associated with an account 500, a recipient, gift card 100, or gift card box 300. For example, a merchant or brand may limit a range of values to be provided on a gift card (e.g., $10 to $100), and a presentation may be of amounts from this range. Alternatively, or additionally, a free-form field may be presented to allow for the input of an amount, though the amount that may be loaded may be restricted to a range. A range may be restricted by a low value and a high value, and it may also be restricted to a whole dollars (or not). Alternatively, there may be no restrictions on the amount.

The permissible load amounts presented or amount input may also serve as verification and/or validation. For example, two or more gift cards 100 may be to the same merchant or brand, and these gift cards 100 may be limited to a range of values. While these gift cards 100 may be to the same merchant or brand, the gift cards 100 may be associated with different ranges. These different ranges may or may not be on the gift card 100. If a gift card 100 does not have the range on the gift card 100, an amount that may be loaded may not be apparent from looking at the gift card 100. When an amount is selected or input, the gift card management system 106 may verify or validate that the amount is in a range associated with the gift card 100. If the amount is not within the range, the gift card management system 106 may provide an alert that the amount is not in the range and/or prompt for a new amount to be selected or input. Additionally, or alternatively, if the amount is not within a range associated with the gift card identification number scanned at step 602 but is within the range of another gift card 100 associated with the account 500 being used, an alert to load the value the other gift card 100 may be provided. The gift cards 100 may have different ranges because a merchant or brand associated the gift card identification numbers 206 with different ranges. For example, in a first month, a first gift card 100 with a first gift card identification number 206 may be provided by a merchant or brand that may have a first range, for example $10 to $100, and in a second month a second gift card 100 with a second gift card identification number 206 may be provide by the same merchant or brand that may have a second range, for example $10 to $250. These gift cards 100 with different ranges may be in the same gift card bundle 302 or gift cards box 300.

Additionally, or alternatively, prior to a confirmation at step 612, a value being loaded to a gift card 100 may trigger another event. In an example of an employee receiving a gift card 100, an event triggered may be a message or communication to an employee congratulating the employee and/or tracking that a gift card 100 was received by an employee as an incentive, a reward, or as compensation. Additionally, or alternatively, the trigger of an event may be any step in FIG. 6, not just the loading of the gift card. Another example of a trigger may be based on location. For example, if a customer is visiting a specific location then a trigger may generate a message or communication reminding the customer of gift cards 100 given the last time the customer was at the location or for the customer to load value to gift cards 100 to give to recipients at the location.

Additionally, or alternatively, a trigger may be provided by gift card management system 106 to a customer's system, such as with an API associated with gift card management system 106. For example, the aforementioned trigger of a message may alternatively have a trigger in the gift card management system 106 that causes, via an API, a message or communication be sent to an employee by a customer's human resources system. In this example, an employee's employer sends a message or communication based on a trigger from the gift card management system 106. In another example, a trigger may be based on a calendar event, such as an anniversary. In an anniversary example, a gift card management system 106 may have a trigger associated with a date that provides a customer's system to take an action, such as sending a message or a communication to a manager of an employee associated with the anniversary. The API may additionally, or alternatively, allow triggers to be generated by a customer's system that triggers the gift card management system 106. For example, the gift card management system 106 may be triggered to load account credit to a customer's account 500 based on a trigger from a customer's system.

An account 500 may be provided information about a recipient, such as after a gift card value has been loaded to a gift card 100 and/or a gift card 100 has been given to a recipient. For example, an account 500 may track recipient data. A gift card management system 106 may be configured to cause a prompt to be provided to provide information about a recipient. In an example of a business scenario with a gift card 100 being provided as an incentive to an employee, the gift card management system 106 may provide a prompt for entry of an employee name or an identifier associated with an employee, which may allow the account to track recipients, such as for tax reporting purposes.

In an alternative embodiment, discussed below, a gift card 100 may not have a merchant or brand associated with the gift card 100. Further, a gift card may be associated with multiple merchants or brands. As a part of the providing value and loading value a customer may additionally input one or more merchants or brands into customer device 102. The merchants and/or brands input are transmitted to the gift card management system 106 with the gift card identification number 206 and the value. The gift card management system 106 will load the value and merchants and/or brands to the gift card. For example, a gift card 100 may be associated with two merchants, such as Best Buy and Target. When a customer inputs the value to be loaded to gift card 100 (e.g., $100) the customer may also input that the value is to be for Best Buy and Target. The gift card management system 106 will receive, among other things, the value and the two merchants and load the value for both merchants. The gift card may then be used at either Best Buy and/or Target until the value loaded (e.g., $100) has been spent.

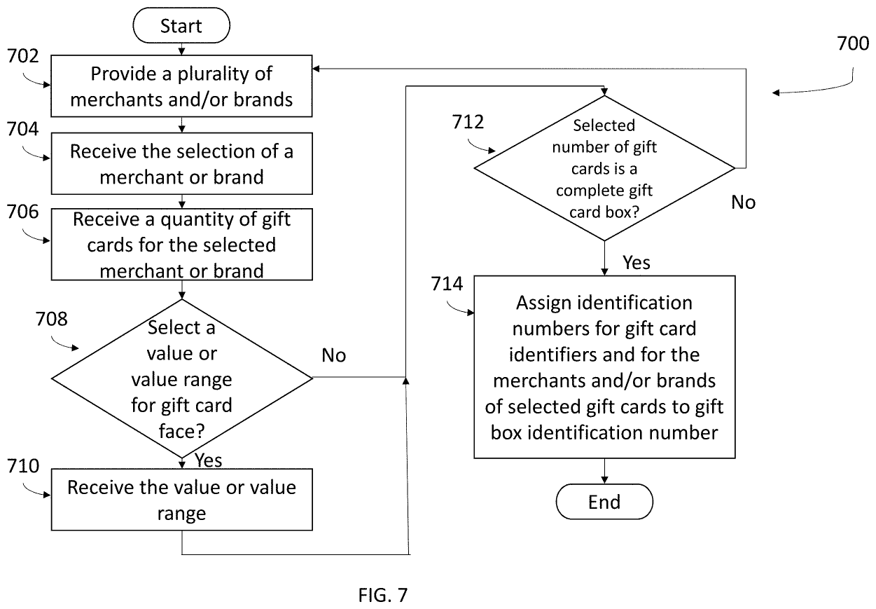

Customers may create personalized gift card boxes 300. FIG. 7 illustrates an example flow chart 700 showing an exemplary method of building a personalized gift card box in accordance with various embodiments of the present disclosure. As discussed above, a gift card box 300 may be filled with gift card bundles 302 from, for example, merchants in a category, such as electronics. Alternatively, a customer may order a gift card box 300 that includes specified gift card bundles 302. This allows a customer to select only gift cards 100 that the customer desires to have, and it may also allow the selection of gift cards 100 from unrelated categories. Additionally, the customer may select to have a value or value range 208 included on the front of each, some, or none of the gift cards 100. The printing of a value or value range 208 of one side of the gift card 100 does not mean that value has yet been loaded on the gift cards 100.

Referring now to FIG. 7, at step 702, a gift card management system 106 provides a customer with a plurality of merchants and/or brands to select. A gift card box 300 may be offered with a set number of gift cards 100 (e.g., 25). Alternatively, the customer may select the size of a gift card box 300, such as, for example, a gift card box 300 having 20 gift cards 100 or, as another example, a gift card box 300 having 50 gift cards 100. At step 704, a customer selects the merchant or brand, and the selection is received by the gift card management system 106. Then the customer may select the quantity of gift cards from the selected merchant or brand to include in the personalized gift card box 300 and, at step 706, the gift card management system 106 receives the quantity. At step 708, the customer may select if a value or value range 208 should be provided so that a gift card 100 in the personalized gift card box 300 will have a value or value range 208 printed on a face of the gift card 100. If the customer chooses to select a value or value range 208, the customer provides the value or value range 208 and, at step 710, the gift card management system receives the value or value range 208. At step 712, the gift card management system 106 determines if the quantity of personalized gift cards 100 the customer has selected results in a complete gift card box 300, and if it is not a complete box then the customer continues to personalize gift cards to include in the personalized gift card box 300. If what the customer has provided results in a complete gift card box 300, the gift card identifiers associated with the gift cards 100 for the personalized gift card box 300 are assigned gift cards 100 and also to the personalized gift cards box 300. Alternatively, a customer may choose to have a partially complete gift card box 300. At step 714, a gift card management system 106 assigns the gift card identification numbers for gift card identifiers 212 and the selected merchants or brands and also assigns a personalized gift card box identification number, assignments may be tracked in a gift card management system as being assigned to a customer's account. Subsequently the gift cards 100 and the personalized gift card box 300 are shipped to the user. In an alternative embodiment, the steps of selecting a value or value range 208 may be omitted. Further, the steps of selecting a value or value range 208 may be before selecting a merchant.

While FIG. 7 illustrates an example flow chart showing an exemplary method of building a personalized gift card box, it will be appreciated that the steps of building a personalized gift card box may occur in a different order and that some steps may be omitted. Any combination of the possible steps disclosed herein may be used. For example, in an alternative embodiment, the selection of a quantity of gift cards 100 for a gift card box 300 may occur first.

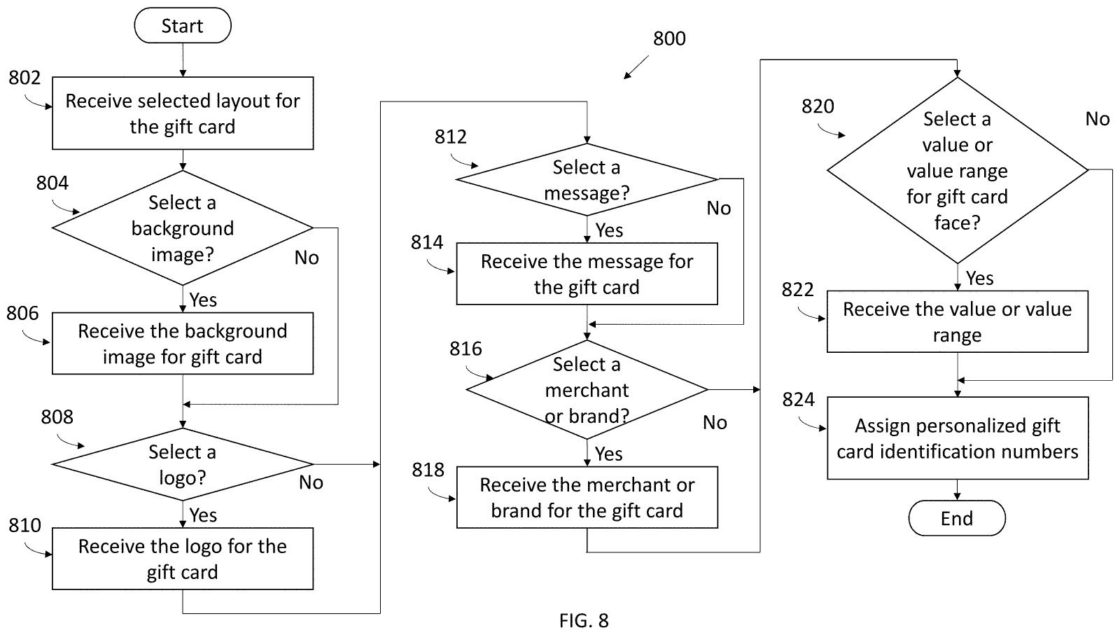

It may be desired to give a personalized gift card. FIG. 8 illustrates an example flow chart 800 showing an example method of building a personalized gift card in accordance with various embodiments of the present disclosure. The personalized gift card may include, for example, a personalized background image, a logo, and/or a personalized message. Additionally, the personalized gift card may be assigned to a merchant or brand and/or assigned a value or value range. The logo may match the merchant assigned. Alternatively, the logo may be different from an assigned merchant. For example, the logo may be the user's business. The background image, logo, personalized message, merchant, and value or value range may be arranged in a prearranged layout or the customer may customize the layout.

Referring now to FIG. 8, at step 802, a layout is selected. The layout may include all or some of a background image, a logo, a personalized message, a merchant name 204, and/or a value or value range 208 to be included on the gift card. While a gift card identifier 212 will be assigned, a customer may also select a location for a gift card identifier 212 on gift card 100. If at decision step 804, it is determined that a background image is to be added then, at step 806, a background image is provided by the customer and received by the gift card management system 106. If at decision step 804 it is determined that no background image is to be added, the personalization goes to step 808. If at decision step 808, it is determined that a logo is to be added then, at step 810, a logo is provided by the customer and received by the gift card management system 106. If at decision step 808 it is determined that no background image is to be added, the personalization goes to step 812. If at decision step 812, it is determined that a message is to be added then, at step 814, a message is provided by the customer and received by the gift card management system 106. If at decision step 812 it is determined that no background image is to be added, the personalization goes to step 816. If at decision step 816, it is determined if a merchant or brand is to be assigned then, at step 816, a merchant or brand is provided by the customer and received by the gift card management system 106. If at decision step 816 it is determined that no merchant or brand is to be assigned, the personalization goes to step 820. If at decision step 820, it is determined if a value or value range is to be added then, at step 822, a value or value range for a face of a gift card 100 is provided by the customer and received by the gift card management system 106. If at decision step 820 it is determined that no value or value range is to be assigned, the personalization goes to step 824. At step 824, the gift card management system 106 assigned a gift card identification number the personalized gift card 100 to have the layout provided along with any background image, logo, message, merchant, and/or value or value range. The personalized gift card 100 will have a gift card identifier 212 corresponding to a personalized gift card identification number. Subsequently the personalized gift card 100 is provided to the customer.

While FIG. 8 illustrates an example flow chart showing an example method of building a personalized gift card, it will be appreciated that the steps of building a personalized gift card may occur in a different order and that some steps may be omitted. Any combination of the possible steps disclosed herein may be used. For example, in an alternative embodiment, the selection of a merchant or brand may occur first.

Alternatively, a gift card 100 may omit a merchant name 204, gift card identification number 206, and value or value range 208, which may be referred to as a blank gift card 100. The blank gift card may only include a gift card identifier 212. The blank gift card 100 may allow for personalization of the blank gift card 100, for example, with a handwritten note or by adding stickers. The blank gift card allows for the assignment of merchants and/or brands and of values in accordance with various embodiments of the present disclosure.

Gift card envelopes 304 may also be personalized by a customer by selection and/or providing a layout, background image, logo, message, value, or merchant or brand that may be used to personalize the gift card envelope 304. Personalized gift card envelopes 304 may then be provided to the customer. There are more than one type of gift card envelopes 304, such as sleeves, window envelopes, open end envelopes, etc. A customer may provide or select a layout, background image, logo, message, value, or merchant or brand for the personalized gift card envelope 304. Personalized gift card envelopes 304 may be designed by a customer and included in a personalized gift card box 300, which may have personalized gift cards 300 or non-personalized gift cards 300 or a mix of both. Alternatively, personalized gift card envelopes 304 may be provided to a customer separately.

Additionally, or alternatively, a wrap or sleeve may be provided for a gift card box 300. The gift card box wrap or gift card box sleeve may be personalized by a customer, such as with a customer selecting and/or providing a layout, background image, logo, message, value, or merchant or brand that may be used. The gift card box wrap or gift card box sleeve may be provided to the customer. For example, if a customer wanted to give a gift card box 300 to a recipient but prefers to personalize the gift of the gift card box 300, the customer may use a gift card box wrap or gift card wrap sleeve to personalize the gift of the gift card box 300 by adding the customer's logo or a personalized message, such as thanking the recipient or recognizing something the recipient has done.

As discussed above, the gift card management system 106 may use the GPS module 460 of customer device 102 to determine the location of the customer device when value is loaded to a gift card. The location may be recorded in the gift card management system 106 and the recordation may also include a timestamp. The location and timestamp information may allow for determination of where and when value to gift cards are being loaded. An account may use this information, for example, to learn that values were loaded to gifts cards during a holiday season, such as immediately before a party, and future needs of gift cards 100 may be determined in view of future parties. In another example, the location may be used for security, such as determining if values are being loaded to a gift card at a remote distance from an address, such as, in an example of a business with an account, a manager being alerted that an employee is attempting to load value to a gift card at a location that is remote from a location associated with an account 500, such as an employee's office. In this example, the employee may be allowed to load value to a card in certain situations, the account may be configured to alert a manager if a value is attempted to be loaded when the employee is away from a specific location, such as an office. Security may also be provided by using location and one or more other factors, such as a time of day in which the value is being loaded, a device ID for a device loading a value, a device's operating system (e.g., Android, iOS) for a device loading a value, payment information, and/or other data associated with an account 500 in database 112. For example, security may be provided by only allowing value to be loaded to a gift card 100 when a loading of value is being done on a customer device 102 having a device ID associated with account 500 during business hours and in an allowed location or area.

Additionally, or alternatively, an alert may be provided if a value being loaded is above a threshold or is unusual. For example, if the loading of a value involves an amount above a predetermined threshold, an alert and/or a request for approval may be sent to a manager. The manager may determine if the loading of value is unauthorized, improper, or fraudulent and, if such a determination is made, the manager may stop the loading of value or void a gift card 100.

Additionally, or alternatively, the location of loading gift card values may assist with compliance with gift card escheatment laws, which may vary among the locations. The gift cards 100 are provided non-activated. The loading of value to a gift card 100 may qualify as a sale under escheatment laws, which may require the reporting of the sale for tax purposes. While sales of gift cards from, for example, a retailer are easy to determine the location of the retailer for reporting purposes, sales of gift cards when purchased online or with a smartphone application may be more difficult, particularly if a purchaser's location may be masked by, for example, a virtual private network. By using the GPS module 460 of customer device 102, the location of the customer at the time of sale may be known. The location may be transmitted from the customer device 102 to the gift card management system 106 and tracked or recorded along with the value. The location along with the value of the sale may be used in reporting sales to an authority (e.g., a department of revenue) in compliance with the appropriate escheatment laws. The gift card management system 106 may generate reports by location, merchant or brand, or any other information in the gift card management system to provide for the reporting of sales.

The customer device may have an application that may have interfaces that allow the customer to login to an account, create an account, select a merchant or brand for a non-activate gift card, capture information corresponding to a gift card identification number (e.g., scan a gift card identifier), choose an amount of value to load to a gift card, confirm the amount of value to load, pay for the amount of value to load, and confirm to the customer that the amount has been and the gift card is activated.

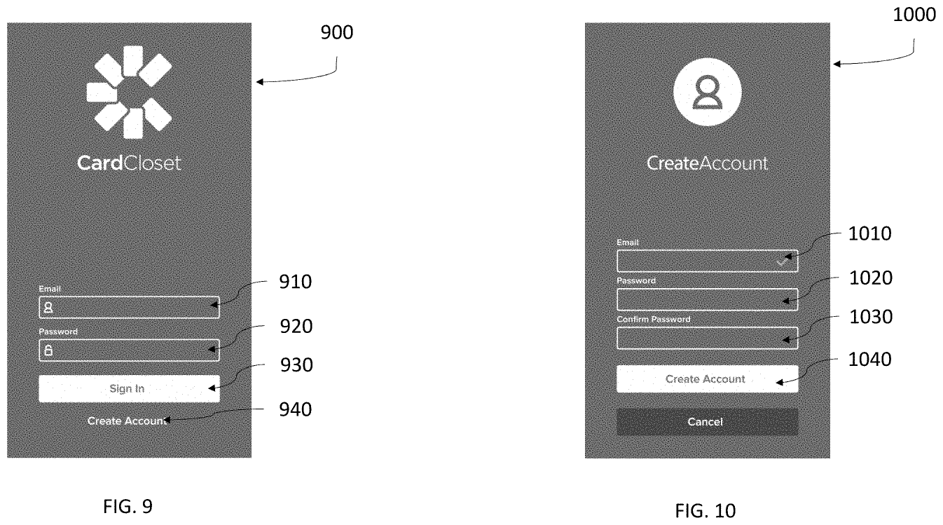

FIG. 9 illustrates an example of an interface in accordance with various embodiments of the present disclosure. Referring to FIG. 9, interface 900 may allow a customer to login or sign in to an already existing account or, alternatively, to create an account. Interface 900 may have a customer name field 910 that may allow a customer to input, for example, a customer's email address. Interface 900 may have a customer password field 920 that may allow a customer to input a customer's password associate with the customer's name. Interface 900 may have a login or sign in icon 930 that may allow a customer to login or sign in with the customer name and associated password. Alternatively, or additionally, the interface 900 may allow for a customer to login or sign in using a biometric identifier, such as a fingerprint or facial recognition. Interface 900 may have a create account icon 940 may allow a user to provide customer name and an associated password to create an account.

FIG. 10 illustrates an example of an interface in accordance with various embodiments of the present disclosure. Referring to FIG. 10, interface 1000 may allow a customer to create an account by providing, for example, a customer name and an associated password. Interface 1000 may have a customer name field 1010 that may allow a customer to provide a customer name for an account, such as, for example, a customer's email address. Interface 1000 may have a password field 1020 that may allow a customer to provide a password to be associated with the customer's name for an account. Interface 1000 may have a password confirmation field 1030 that may allow a customer to provide a confirmation of the password to be associated with the customer's name for an account. Interface 1000 may have a create account icon 1040 may allow a user to create an account with the customer name and an associated password. Account creation may additionally, or alternatively, have a customer provide additional information, such as the customer name, home address, business address, home phone number, mobile phone number, business phone number, and/or payment information that may be associated with the account.

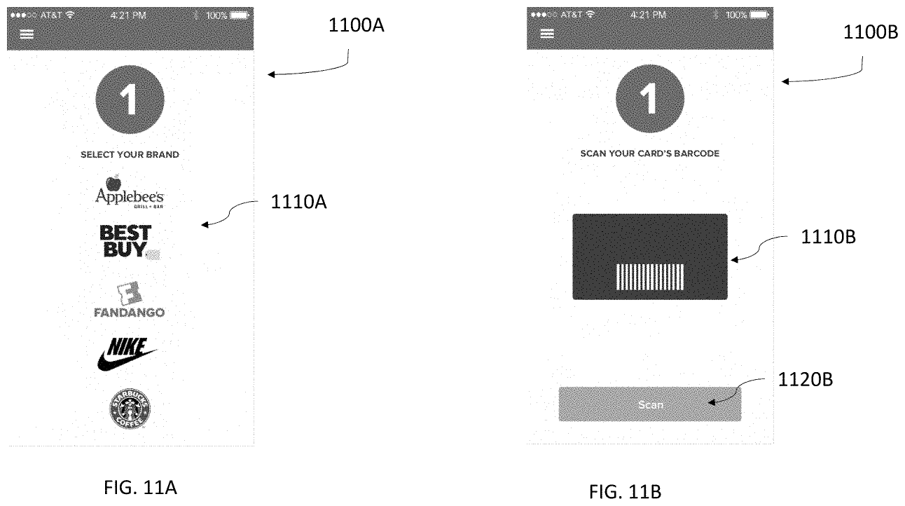

FIG. 11A illustrates an example of an interface in accordance with various embodiments of the present disclosure. Referring to FIG. 11A, interface 1100A may allow a customer logged in or signed in to a customer account to select a merchant or brand for a non-activated gift card. Interface 1100A may have a plurality of merchant or brand icons 1110A that a customer may select from. For example, the plurality of merchants or brands may include Applebee's Grill & Bar, Best Buy, Fandango, NIKE, or Starbucks Coffee. A customer may, for example, select a merchant or brand by selecting the merchant of brand icon 1110A. Alternatively, not shown, a customer may search for a merchant of brand by name or location or enter a merchant or brand into a field. A search by location may, for example, be based on the proximity of a merchant or brand store to the customer or to a location the customer specifies.

FIG. 11B illustrates an example of an interface in accordance with various embodiments of the present disclosure. Referring to FIG. 11B, interface 1100B may allow a customer logged in or signed in to a customer account to use a customer device 102 to capture information corresponding to a gift card identification number (e.g., identifier 212B, 212C, or 212D) on a gift card 100. For example, a customer may scan a card's barcode. In one example, the gift card 100 may be associated with a brand, and capturing the gift card identifier 212B, 212C, or 212D may provide all of the information necessary to associate the gift card with a merchant or brand. Alternatively, the customer may select a merchant or brand, such as with interface 1100A. Interface 1100B may have an icon 1120B that may be for capturing or scanning a gift card identifier. As discussed above, capturing or scanning may be completed with optical recognition. Alternatively, the icon 1120B may be for capturing or scanning information corresponding to a gift card identification number.

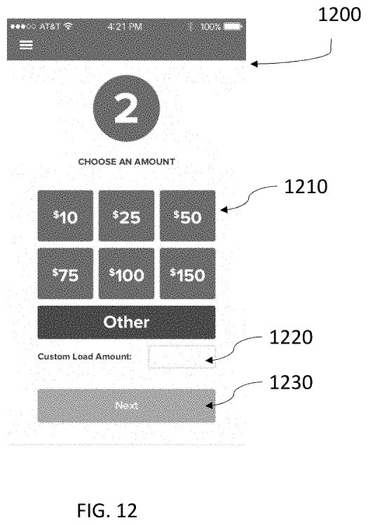

FIG. 12 illustrates an example of an interface in accordance with various embodiments of the present disclosure. Referring to FIG. 12, interface 1200 may allow a customer to provide an amount of value to load to a gift card 100. Interface 1200 may have one or more amount icons 1210 that may allow a customer to quickly select an amount of value to be loaded (e.g., $10, $25, $50, $75, $100, or $150). The one or more amount icons 1210 may change color, shape, be altered to indicate that the customer has selected one of the one or more amount icons. Additionally, the one or more amount icons 1210 may include an icon to indicate that the customer will specify an amount (e.g., a custom amount). Interface 1200 may have an amount field 1220 that may allow a customer to provide an amount. Interface 1200 may have an icon 1230 that may allow a customer to confirm the amount.

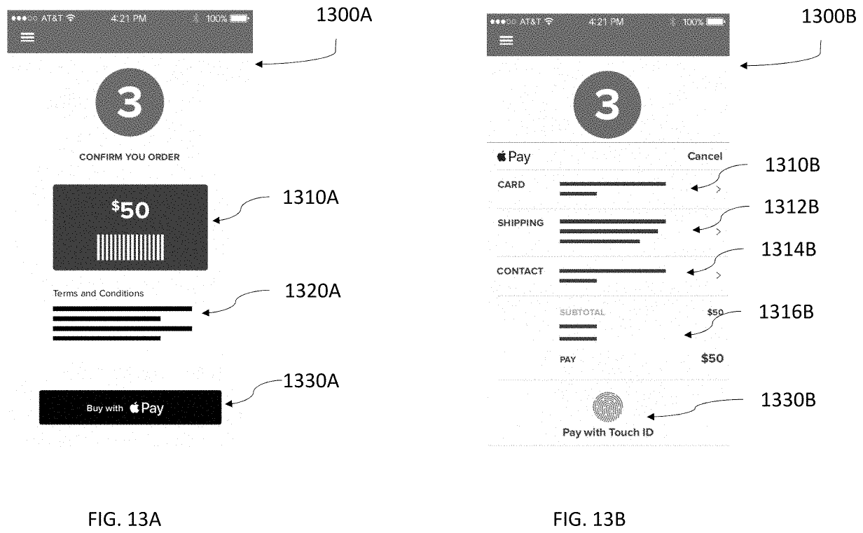

FIG. 13A illustrates an example of an interface in accordance with various embodiments of the present disclosure. Referring to FIG. 13A, interface 1300A may allow a customer to confirm the amount of value to load to a gift card 100. Interface 1300A may have a confirmation icon 1310A that may confirm the gift card 100 to activate and may also include the amount of value to be loaded to the gift card. The confirmation icon 1310A may have additional information, such as a merchant or brand. Interface 1300A may include terms and conditions 1320A that may provide a customer with any terms and conditions that apply. Interface 1300A may have a payment icon 1330A that may provide one or more options of payment processing options for the customer to choose. For example, a customer's account may have stored information for one or more payment processing options, such as credit card numbers, checking account information and/or number(s), debit account information and/or number(s), wire transfer information and/or number(s), ACH Network information and/or number(s), account credit, PayPal, or Apple pay. Additionally, or alternatively, a customer's account may have credit on the account that was previously put on the customer's account, which the customer may choose for payment processing. In one embodiment, selection of the payment icon 1330A may cause payment to process and the specified amount of value to be loaded to the gift card 100. In an alternative embodiment, selection of the payment icon 1330A may allow the customer to confirm payment processing information.

FIG. 13B illustrates an example of an interface in accordance with various embodiments of the present disclosure. Referring to FIG. 13B, interface 1300B may allow a customer to confirm payment processing information. For example, and as shown in FIG. 13B, the payment information (e.g., card information 1310B), a shipping address (e.g., shipping information 1312B), a contact's information (e.g., contact information 1314B), and an amount (e.g., payment amount 1316B). Interface 1300A may have a payment icon 1330B that may cause the payment to occur.

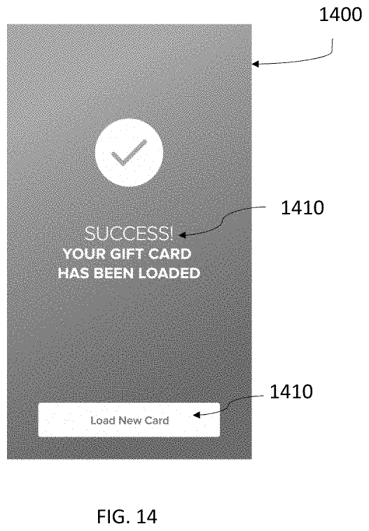

FIG. 14 illustrates an example of an interface in accordance with various embodiments of the present disclosure. Referring to FIG. 14, interface 1400 may provide a confirmation of the amount of value being loaded to the gift card 100. The interface 1400 may have an icon 1410 that may allow a customer to load an amount of value to another gift card.

Additionally, an application may allow a customer to input recipient information associated with who a gift card was given to (e.g., recipient data). Additionally, a recipient may also use an application and, via an interface, to create an account, login to an account, input recipient information, confirm receiving a gift card 100, associate a gift card 100 with the recipient's account, and/or load value to a gift card 100 if it was given without being loaded. For example, a recipient may be an employee and a manager associated with a customer account 500 may give the recipient employee a gift card 100 as recognition and/or an incentive. The manager may provide to the gift card management system 106 with a value associated with the gift card 100 given to the recipient employee and the manager may give the recipient employee a gift card 100 that has not been loaded. This may occur if the employee may be allowed to choose a merchant or brand. The employee may create an account, provide recipient information, and, when the employee chooses to, choose a merchant or brand and load value to the gift card 100. The loading of value by the recipient and not the giver may, for example, assist a with cash flow by loading value not when a gift card 100 is given but when a recipient may later load value to the gift card 100.

Additionally, or alternatively, the gift card management system 106 may provide alerts. For example, a company may have an account 500 and the account may have multiple users 504. In this example, a user 504 may be a manager that is encouraged to give gift cards 100 as recognition and/or incentives to employees. The company may load account 500 such that it has account credit that is to be used by the manager within a time period (e.g., a month or quarter) or, alternatively, the company may allocate an amount that the manager may load to gift cards 100 within a time period. Near the end of the time period, if the amount the manager has loaded to gift cards 100 is lower than the amount loaded to account 500 or the amount allocated to the manager, the manager may receive an alert. The alert may provide the remaining amount that the manager may load to gift cards 100, or the alert may encourage the manager to recognize employees.

Many modifications and other embodiments of the present disclosure set forth herein will come to mind to one skilled in the art having the benefit of the teachings presented in the foregoing description and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. A system for loading value to a gift card, comprising:
a gift card comprising information corresponding to a gift card identification number;
a customer device comprising a user interface and an optical input device; and
a remote server configured to communicate with the customer device and with a gift card database;
wherein the customer device is configured to:
optically recognize, on the gift card, the information corresponding to the gift card identification number with the optical input device;
receive input via the user interface of a value to load to the gift card;
transmit at least one of the information corresponding to the gift card identification number and the gift card identification number for the gift card, the value, and an account number to the remote server;
wherein the remote server is configured to:
receive the at least one of the information corresponding to the gift card identification number and the gift card identification number for the gift card, the value, and the account number from the customer device;
access the gift card database, wherein the gift card database contains information of a plurality of gift cards, including a gift card identification number assigned to each of the plurality of gift cards;
determine if the received information corresponding to the gift card identification number or gift card identification number is in the gift card database for the gift card; and
in response to determining that received information corresponding to the gift card identification number or gift card identification number is in the gift card database for the gift card, load the value to the gift card database for the gift card identification number of the gift card.

2. The system for loading value to a gift card of claim 1, wherein the remote server is further configured to determine if the received information corresponding to the gift card identification number or gift card identification number for the gift card is assigned to the account number.

3. The system for loading value to a gift card of claim 1, further comprising determining the gift card identification number from the information corresponding to the gift card identification number.

4. The system for loading value to a gift card of claim 3, wherein determining the gift card identification number comprises, determining, by the customer device, the gift card identification number from the optically recognized information corresponding to the gift card identification number.

5. The system for loading value to a gift card of claim 3, wherein determining the gift card identification number comprises, determining, by the remote server, the gift card identification number by matching the information corresponding to the gift card identification number with the gift card identification number in the gift card database.

6. The system for loading value to a gift card of claim 1, wherein the information corresponding to the gift card identification number is a gift card identifier.

7. The system for loading value to a gift card of claim 6, wherein the gift card identifier is at least one of a barcode and a QR code.

8. The system for loading value to a gift card of claim 1, wherein the customer device is further configured to determine a location of the customer device; wherein the customer device is further configured to transmit the location to the remote server; and the remote server is further configured to record the location to the gift card database for the gift card identification number.

9. The system for loading value to a gift card of claim 1, wherein the remote server is further configured to transmit a confirmation that the value has been loaded.

10. The system of loading value to a gift card of claim 1, wherein the remote server is further configured to process payment for the value loaded.

11. A method for loading value to a gift card, comprising:
optically recognizing, via an optical input device of a customer device, information corresponding to a gift card identification number on a gift card;
determine the gift card identification number of the gift card from the optically recognized information corresponding to the gift card identification number;
receiving, via a user interface of the customer device, a value to load to the gift card;
transmitting, from the customer device to a remote server, the value, the gift card identification number, and an account number;
receiving, at the remote server, the value, the gift card identification number, and the account number from the customer device;
determining if the received gift card identification number is in a gift card database that contains information of a plurality of gift cards, including a gift card identification number assigned to each of the plurality of gift cards;
loading the value to the gift card database for the received gift card identification number in response to determining that the gift card identification number is in the gift card database; and
transmitting a confirmation from the remote server to the customer device that the value has been loaded.

12. The method for loading value to a gift card of claim 11, further comprising determining, prior to loading the value, if the received gift card identification number is assigned to the account number.

13. The method for loading value to a gift card of claim 11, wherein the gift card information corresponding to the gift card identification number is a gift card identifier.

14. The method for loading value to a gift card of claim 13, wherein the gift card identifier is at least one of a barcode and a QR code.

15. The method for loading value to a gift card of claim 11, further comprising:
determining a location of the customer device;
transmitting the location from the customer device to the remote server along with the value and gift card identification number; and
recording the location to the gift card database along with the value.

16. The method for loading value to a gift card of claim 11, wherein the gift card database that contains information of a plurality of gift cards further contains a first merchant or a first brand assigned to the gift card identification number; and transmitting the first merchant or the first brand from the remote server to the customer device along with that the value has been loaded.

17. The method of loading value to a gift card of claim 11, further comprising processing, by the remote server, payment for the value loaded.

18. A system for providing a gift card, comprising:
a gift card box comprising information corresponding to a gift card box identification number and a plurality of gift cards, wherein each of the plurality of gift cards comprises information corresponding to a gift card identification number;
a customer device comprising a user interface and an optical input device; and
a remote server configured to communicate with the customer device and with a gift card database;
wherein the customer device is configured to:
optically recognize the information corresponding to the gift card box identification number with the optical input device to capture the gift card box identification number;
determine the gift card box identification number;
transmit account information corresponding to an account of a customer of the customer device and the gift card box identification number to the remote server;
wherein the remote server is configured to:
receive the account information and the gift card box identification number from the customer device;
access the gift card database, wherein the gift card database contains information of a plurality of gift card boxes and information of a plurality of gift cards, including (A) a gift card box identification number assigned to each of the plurality of gift card boxes, (B) a gift card identification number assigned to each of the plurality of gift cards, and (C) the gift card identification numbers assigned to each of the plurality of gift card boxes;
determine if the received gift card box identification number is in the gift card database; and
in response to determining that gift card identification number received is in the gift card database, assign the gift card identification numbers assigned to the gift card box identification number received to the account of the customer.

19. The system for providing a gift card of claim 18, wherein the gift card box is purchased from a store at a physical location.

20. The system for providing a gift card of claim 18, wherein the remote server is further configured to:
receive a selection of gift cards for an account;
allocate the selection of gift cards to the gift card box;
transmit instructions to deliver the gift card box to the customer;
determine that the gift card box was delivered to the customer in response to determining that the received gift card box identification number in the gift card database.

21. The system for providing a gift card of claim 18, wherein the gift card box information corresponding to the gift card identification number is a gift card identifier.

22. The system for providing a gift card of claim 21, wherein the gift card box identifier is at least one of a barcode and a QR code.

23. The system for providing a gift card of claim 18, wherein remote server is further configured to transmit a confirmation that the gift cards associated with the gift card identification numbers assigned to the gift card box identification number has been assigned to the account.

24. A method for providing a gift card, comprising:
optically recognizing, via an optical input device of a customer device, information corresponding to a gift card box identification number on a gift card box;
determine the gift card box identification number of the gift card box from the optically recognized information corresponding to the gift card box identification number;
transmitting, from the customer device to a remote server, account information corresponding to an account of a customer of the customer device and the gift card box identification number;
receiving, at the remote server from the customer device, the gift card box identification number and the account information;
determining if the received gift card box identification number is in a gift card database that contains information of a plurality of gift card boxes and information of a plurality of gift cards, including (A) a gift card box identification number assigned to each of the plurality of gift card boxes, (B) a gift card identification number assigned to each of the plurality of gift cards, and (C) the gift card identification numbers assigned to each of the plurality of gift card boxes;
assigning the gift card identification numbers assigned to the gift card box identification number received to the account of the customer in response to determining that the gift card box identification number is in the gift card database.

25. The method for providing a gift card of claim 24, further comprising:
receiving, prior to operatically recognizing information corresponding to a gift card box, a selection of gift cards;
allocating the selection of gift cards to the gift card box;
transmitting instructions to deliver the gift card box to the customer;
determining, contemporaneously with determining if the received gift card box identification number is in a gift card database, that the gift card box was delivered to the customer in response to determining that the received gift card box identification number in the gift card database.

26. The method for providing a gift card of claim 24, wherein the gift card box information corresponding to the gift card identification number is a gift card box identifier comprising at least one of a barcode and a QR code.

27. The method for providing a gift card of claim 24, further comprising transmitting a confirmation that the gift cards associated with the gift card identification numbers assigned to the gift card box identification number has been assigned to the account of the customer.
